(19) United States
(12) Patent Application Publication
(10) Pub. No.: US 2025/0103450 A1
(43) Pub. Date: Mar. 27, 2025

(54) DATABASE DISASTER RECOVERY SYSTEM, METHOD, AND APPARATUS, STORAGE MEDIUM, AND ELECTRONIC DEVICE

(71) Applicant: BEIJING OCEANBASE TECHNOLOGY CO., LTD., Beijing (CN)

(72) Inventors: Zhenkun YANG, Beijing (CN); Hao LIU, Beijing (CN); Fusheng HAN, Beijing (CN)

(21) Appl. No.: 18/974,625

(22) Filed: Dec. 9, 2024

Related U.S. Application Data
(63) Continuation of application No. PCT/CN2023/110174, filed on Jul. 31, 2023.

(30) Foreign Application Priority Data
Dec. 6, 2022 (CN) 202211559350.2

(51) Int. Cl. G06F 11/20; G06F 16/27; H04L 67/104

(52) U.S. Cl. CPC G06F 11/2028; G06F 16/273; H04L 67/1051

(57) ABSTRACT

The present specification discloses a database disaster recovery system, method, and apparatus, a storage medium, and an electronic device. In the database disaster recovery system provided in the present specification, the system includes a first database. A data processing node in the first database synchronizes a log generated for a database operation to at least one data protection node based on a distributed consistency protocol. The data protection node receives and stores the log. In response to some data processing nodes in the first database experiencing an anomaly, a data processing node without an anomaly in the first database provides a database service based on logs stored in the data protection node, thereby implementing disaster recovery for the first database. It can be learned from the above system that, the system can implement disaster recovery without data loss for the first database based on the distributed consistency protocol by using the data protection node independent of the data processing node.

### TECHNICAL FIELD

The present application relates to the computer field, and in particular, to a database disaster recovery system, method, and apparatus, a storage medium, and an electronic device.

### BACKGROUND

With continuous development of Internet technologies, databases are increasingly widely applied.

If a database becomes abnormal, some businesses that need to be provisioned by the database cannot be performed normally. Therefore, database disaster recovery is essential. As database technologies continue to advance, most enterprises use distributed databases to provide database services. In a distributed database, there are multiple data processing nodes, each of which can serve as a master node. Once a data processing node is designated as the master node, it performs database operations, generates logs corresponding to these operations, and synchronizes these logs to other data processing nodes based on a distributed consistency protocol. Under normal circumstances, if some data processing nodes in a distributed database experience anomalies, database disaster recovery allows other normal data processing nodes to provide database services. However, if a significant number of data processing nodes become abnormal, it is possible that all nodes that successfully synchronized logs for certain database operations also become abnormal. This means that the logs for these database operations are lost. As a result, data loss can still occur even if other data processing nodes without anomalies provide the database services.

### SUMMARY

The present specification provides disaster recovery protection for databases without data loss. The present specification provides a database disaster recovery system, method, and apparatus, a storage medium, and an electronic device, which, among others, resolve at least some of the technical problems in the related technologies.

The present specification uses the following technical solutions: The present specification provides a database disaster recovery system, and the system includes at least a first database and a second database. The first database includes at least one data processing node and at least one data protection node. The data protection node and the data processing node are independent of each other. The data processing node generates, in response to a received database operation, a log corresponding to the database operation, and synchronizes the log to all other data processing nodes and all data protection nodes in the first database, so that each of the data processing nodes and the data protection nodes synchronizes the log to at least one data protection node under the condition of meeting distributed consistency. The data protection node receives and stores the log synchronized by the data processing node. In response to the first database experiencing an anomaly of a first type, a data processing node without an anomaly in the first database provides a database service based on logs stored in the data protection node.

In some implementations, the data protection node has an independent power supply and an independent communications apparatus.

In some implementations, the data processing node synchronizes the log to all the other data processing nodes and all the data protection nodes in the first database, and receives log saving success messages returned by the other data processing nodes and the data protection nodes, and determines, based on the log saving success messages, whether the log has been synchronized to at least one data protection node under the condition of meeting distributed consistency.

In some implementations, the data processing node determines, based on the number of all the data processing nodes, a weight of the log saving success message returned by the data protection node, and determines the sum of the weights of the log saving success messages returned by all the data protection nodes as a first weight; determines, based on the number of all the data protection nodes, a weight of the log saving success message returned by the data processing node, and determines the sum of the weights of the log saving success messages returned by all the data processing nodes as a second weight; and in response to the sum of the first weight and the second weight being greater than a predetermined threshold, determines that the log has been synchronized to at least one data protection node under the condition of meeting distributed consistency.

In some implementations, the system further includes a second database; in response to the first database experiencing an anomaly of a second type, the data protection node synchronizes, to the second database, the logs saved by the data protection node; and the second database is configured to provide a database service after receiving the logs synchronized by the data protection node.

In some implementations, in response to the first database experiencing no anomaly, the data processing node and/or the data protection node asynchronously transmit/transmits, to the second database, logs saved by the data processing node and/or the data protection node.

In some implementations, the first database further includes at least one election node. For each of the data processing nodes, in response to determining that the data processing node itself is a master-eligible node, the data processing node sends a master node election request to the other data processing nodes and all the data protection nodes, and receives master node election messages returned by the other data processing nodes and all the data protection nodes; and in response to determining, based on the master node election messages, that the data processing node itself is a master node, the data processing node generates, in response to the received database operation, the log corresponding to the database operation, and synchronizes the log to all the other data processing nodes and all the data protection nodes in the first database; and in response to being incapable of determining the master node based on the master node election messages, the data processing node sends a master node election request to the other data processing nodes, all the data protection nodes, and the election node, receives master node election messages returned by the other data processing nodes, all the data protection nodes, and the election node, and determines the master node based on the master node election messages returned by the other data processing nodes, all the data protection nodes, and the election node.

The present specification provides a database disaster recovery method, and the method is applied to a data processing node in a first database. The first database includes at least one data processing node and at least one data protection node. The data protection node and the data processing node are independent of each other. The method includes: generating, in response to a received database operation, a log corresponding to the database operation; synchronizing the log to all other data processing nodes and all data protection nodes in the first database, so that each of the data processing nodes and the data protection nodes synchronizes the log to at least one data protection node for storage under the condition of meeting distributed consistency; and in response to the first database experiencing an anomaly of a first type and the data processing node itself experiencing no anomaly, providing a database service based on logs stored in the data protection node.

In some implementations, the data protection node has an independent power supply and an independent communications apparatus.

In some implementations, the synchronizing the log to at least one data protection node in some implementations includes: synchronously transmitting the log to all the other data processing nodes and all the data protection nodes in the first database; receiving log saving success messages returned by the other data processing nodes and the data protection nodes; and determining, based on the log saving success messages, whether the log has been synchronized to at least one data protection node under the condition of meeting distributed consistency.

In some implementations, the determining whether the log has been synchronized to at least one data protection node under the condition of meeting distributed consistency in some implementations includes: determining, based on the number of all the data processing nodes, a weight of the log saving success message returned by the data protection node, and determining the sum of the weights of the log saving success messages returned by all the data protection nodes as a first weight; and determining, based on the number of all the data protection nodes, a weight of the log saving success message returned by the data processing node, and determining the sum of the weights of the log saving success messages returned by all the data processing nodes as a second weight; determining whether the sum of the first weight and the second weight is greater than a predetermined threshold; and in response to the sum of the first weight and the second weight being greater than the predetermined threshold, determining that the log has been synchronized to at least one data protection node under the condition of meeting distributed consistency; or in response to the sum of the first weight and the second weight being not greater than the predetermined threshold, determining that the log has not been synchronized to at least one data protection node under the condition of meeting distributed consistency.

In some implementations, the method further includes: in response to the first database experiencing no anomaly, asynchronously transmitting, to the second database, logs saved by the data processing node itself.

In some implementations, the first database further includes at least one election node; the generating, in response to the received database operation, the log corresponding to the database operation in some implementations includes: in response to determining that the data processing node itself is a master-eligible node, sending a master node election request to the other data processing nodes and all the data protection nodes; receiving master node election messages returned by the other data processing nodes and all the data protection nodes; and in response to determining, based on the master node election messages, that the data processing node itself is a master node, generating, in response to the received database operation, the log corresponding to the database operation; and the method further includes: in response to being incapable of determining the master node based on the master node election messages, sending a master node election request to the other data processing nodes, all the data protection nodes, and the election node; receiving master node election messages returned by the other data processing nodes, all the data protection nodes, and the election node; and determining the master node based on the master node election messages returned by the other data processing nodes, all the data protection nodes, and the election node.

The present specification provides a database disaster recovery method, and the method is applied to a data protection node in a first database. The first database includes at least one data processing node and at least one data protection node. The data protection node and the data processing node are independent of each other. The method includes: receiving and storing a log synchronously transmitted by the data processing node, the log being a log generated by the data processing node in response to a received database operation and corresponding to the database operation; and in response to the first database experiencing an anomaly of a first type, providing, by the data protection node, logs stored by the data protection node itself to a data processing node without an anomaly in the first database, so that the data processing node without an anomaly provides a database service based on the logs provided by the data protection node.

In some implementations, the data protection node has an independent power supply and an independent communications apparatus.

In some implementations, the method further includes: in response to the first database experiencing an anomaly of a second type, synchronizing, to the second database, the logs saved by the data protection node, the second database being configured to provide a database service after receiving the logs synchronized by the data protection node.

In some implementations, the method further includes: in response to the first database experiencing no anomaly, asynchronously transmitting, to the second database, the logs saved by the data protection node itself.

The present specification provides a database disaster recovery apparatus, and the apparatus is applied to a data processing node in a first database. The first database includes at least one data processing node and at least one data protection node. The data protection node and the data processing node are independent of each other. The apparatus includes: a response module, configured to generate, in response to a received database operation, a log corresponding to the database operation; a synchronization module, configured to synchronize the log to all other data processing nodes and all data protection nodes in the first database, so that each of the data processing nodes and the data protection nodes synchronizes the log to at least one data protection node for storage under the condition of meeting distributed consistency; and a service module, configured to: in response to the first database experiencing an anomaly of a first type and the apparatus itself experiencing no anomaly, provide a database service based on logs stored in the data protection node.

In some implementations, the data protection node has an independent power supply and an independent communications apparatus.

In some implementations, the synchronization module is in some implementations configured to: synchronize the log to all the other data processing nodes and all the data protection nodes in the first database for storage; receive log saving success messages returned by the other data processing nodes and the data protection nodes; and determine, based on the log saving success messages, whether the log has been synchronized to at least one data protection node under the condition of meeting distributed consistency.

In some implementations, the synchronization module is in some implementations configured to: determine, based on the number of all the data processing nodes, a weight of the log saving success message returned by the data protection node, and determine the sum of the weights of the log saving success messages returned by all the data protection nodes as a first weight; and determine, based on the number of all the data protection nodes, a weight of the log saving success message returned by the data processing node, and determine the sum of the weights of the log saving success messages returned by all the data processing nodes as a second weight; determine whether the sum of the first weight and the second weight is greater than a predetermined threshold; and in response to the sum of the first weight and the second weight being greater than the predetermined threshold, determine that the log has been synchronized to at least one data protection node under the condition of meeting distributed consistency; or in response to the sum of the first weight and the second weight being not greater than the predetermined threshold, determine that the log has not been synchronized to at least one data protection node under the condition of meeting distributed consistency.

In some implementations, the apparatus further includes a first transmission module, configured to: in response to the first database experiencing no anomaly, asynchronously transmit, to the second database, the logs saved by the apparatus itself.

In some implementations, the first database further includes at least one election node. The response module is in some implementations configured to: in response to determining that the apparatus is a master-eligible node, send a master node election request to the other data processing nodes and all the data protection nodes; receive master node election messages returned by the other data processing nodes and all the data protection nodes; and in response to determining, based on the master node election messages, that the apparatus itself is a master node, generate, in response to the received database operation, the log corresponding to the database operation; and the synchronization module is further configured to: in response to being incapable of determining the master node based on the master node election messages, send a master node election request to the other data processing nodes, all the data protection nodes, and the election node; receive master node election messages returned by the other data processing nodes, all the data protection nodes, and the election node; and determine the master node based on the master node election messages returned by the other data processing nodes, all the data protection nodes, and the election node.

The present specification provides a database disaster recovery apparatus, and the apparatus is applied to a data protection node in a first database. The first database includes at least one data processing node and at least one data protection node. The data protection node and the data processing node are independent of each other. The apparatus includes: a receiving module, configured to receive and store a log synchronously transmitted by the data processing node to the data protection node, the log being a log generated by the data processing node in response to a received database operation and corresponding to the database operation; and a provision module, configured to: in response to the first database experiencing an anomaly of a first type, provide logs stored by the apparatus itself to a data processing node without an anomaly in the first database, so that the data processing node without an anomaly provides a database service based on the logs provided by the apparatus.

In some implementations, the apparatus has an independent power supply and an independent communications apparatus.

In some implementations, the apparatus further includes a second transmission module, configured to: in response to the first database experiencing an anomaly of a second type, synchronize, to the second database, the logs saved by the apparatus itself, the second database being configured to provide a database service after receiving the logs synchronized by the apparatus.

In some implementations, the second transmission module is in some implementations configured to: in response to the first database experiencing no anomaly, asynchronously transmit, to the second database, the logs saved by the apparatus itself.

The present specification provides a computer-readable storage medium. The storage medium stores a computer program, and when the computer program is executed by a processor, the above database disaster recovery method is implemented.

The present specification provides an electronic device, including: a memory, a processor, and a computer program that is stored in the memory and can run on the processor. The processor implements the above database disaster recovery method when executing the program.

At least one of the technical solutions mentioned above in the present specification can achieve the following beneficial effects. A database disaster recovery system provided in the present specification includes a first database. A data processing node in the first database synchronizes a log generated for a database operation to at least one data protection node based on a distributed consistency protocol. The data protection node receives and stores the log. In response to some data processing nodes in the first database experiencing an anomaly, a data processing node without an anomaly in the first database provides a database service based on logs stored in the data protection node, thereby implementing disaster recovery for the first database.

It can be learned from the above system that, the system can implement disaster recovery without data loss for the first database based on the distributed consistency protocol by using the data protection node independent of the data processing node.

### DESCRIPTION OF THE DRAWINGS

The accompanying drawings illustrated herein are provided for further understanding of the present specification and form a part of the present specification. The example implementations of the present specification and the descriptions thereof are used to explain the present specification and do not constitute an improper limitation on the present specification. In the drawings:

FIG. 1 is a schematic diagram of a database disaster recovery system according to the present specification;

FIG. 2 is a schematic diagram of another database disaster recovery system according to the present specification;

FIG. 3 is a schematic diagram of still another database disaster recovery system according to the present specification;

FIG. 4 is a schematic flowchart of a database disaster recovery method according to the present specification;

FIG. 5 is a schematic flowchart of another database disaster recovery method according to the present specification;

FIG. 6 is a schematic diagram of a database disaster recovery apparatus according to the present specification;

FIG. 7 is a schematic diagram of another database disaster recovery apparatus according to the present specification; and

FIG. 8 is a schematic diagram of an electronic device corresponding to FIG. 4 or FIG. 5 according to the present specification.

### DESCRIPTION OF EMBODIMENTS

To make the technical features, technical solutions, and improvements of the present specification clearer, the following clearly and comprehensively describes the technical solutions in the present specification with reference to example implementations of the present specification and corresponding accompanying drawings. Clearly, the described implementations are merely some rather than all of the implementations of the present specification. All the other implementations obtained by a person of ordinary skill in the art based on the implementations of the present specification without making innovative efforts shall fall within the protection scope of the present application.

The technical solutions provided in the implementations of the present specification are described in detail below with reference to the accompanying drawings.

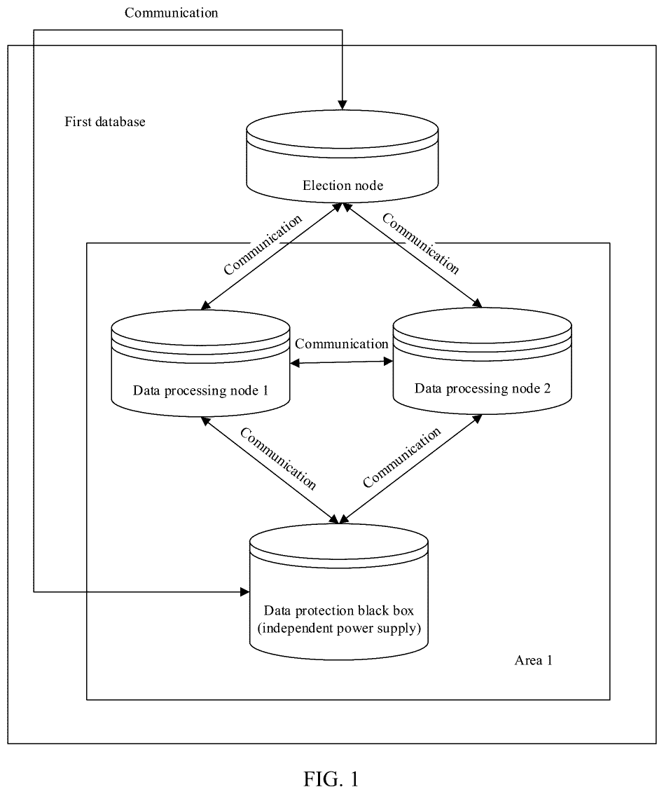

FIG. 1 is a schematic diagram of a database disaster recovery system according to the present specification. The system includes at least a first database. The first database can be a distributed database, or can be a common or centralized database. The first database includes at least one data processing node and at least one data protection node. The data protection node and the data processing node are independent of each other. As shown in FIG. 1, the system can include a data processing node 1, a data processing node 2, and a data protection node. Every two of the data processing node 1, the data processing node 2, and the data protection node are communicatively connected. In response to the first database being a distributed database, the data processing node 1 is configured or selected as a master node (or the data processing node 2 can be selected). The master node generates, in response to a received database operation, a log corresponding to the database operation, and synchronizes the log to all other data processing nodes and all data processing nodes in the first database, so that each of the data processing nodes and the data protection nodes synchronizes the log to at least one data protection node under the condition of meeting distributed consistency. The data protection node receives and stores the log synchronized by the data processing node. It should be noted that the master node synchronizes the log to all the other data processing nodes and all the data protection nodes in the first database in a synchronous transmission manner. The database operation includes but is not limited to a data manipulation language (DML) operation, such as add, delete, query, or modify.

As described herein, when the first database is a distributed database, all nodes, e.g., the data processing node and the data protection node, in the first database meet a distributed consistency protocol during execution of a database operation. In addition, the master node further synchronously transmits a log generated by performing the database operation to at least one data protection node. In some implementations, the master node synchronously transmits the log to all the other data processing nodes and all the data protection nodes in the first database; receives log saving success messages returned by the other data processing nodes and the data protection nodes; and determines, based on the log saving success messages, whether the log has been synchronized to at least one data protection node under the condition of meeting distributed consistency.

In response to the other data processing nodes and the data protection nodes returning the log saving success messages, it indicates that the log can be successfully synchronized on sending parties of the log saving success messages. Therefore, it can be determined, based on the log saving success messages, whether the nodes in the first database meet the distributed consistency protocol and whether the log has been synchronized to at least one data protection node, that is, it can be determined, based on the log saving success messages, whether the master node has synchronized the log to at least one data protection node under the condition of meeting distributed consistency.

Multiple data processing nodes can possibly be present in the first database. An anomaly of the first database is classified into an anomaly of a first type or an anomaly of a second type based on the number of abnormal data processing nodes. In response to all the data processing nodes being damaged, this anomaly is an anomaly of the second type. In response to some data processing nodes experiencing an anomaly (the number of data processing nodes being damaged is not less than 1 and is less than the total number of the data processing nodes), such an anomaly is referred to as an anomaly of the first type.

In response to the first database experiencing an anomaly of the first type and the data processing node (master node) itself experiencing no anomaly, a database service is provided based on logs stored in the data protection node.

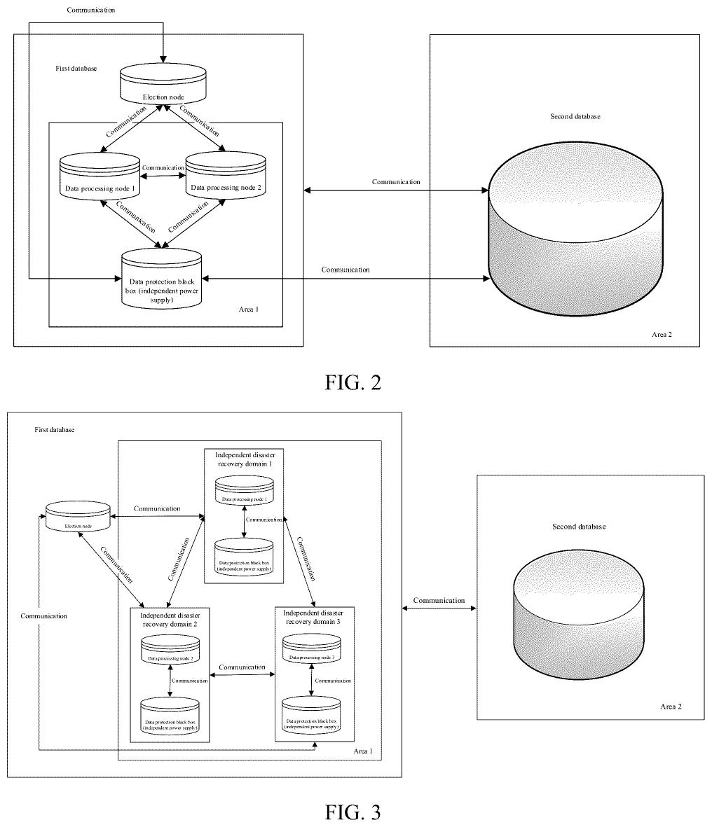

To prevent the first database from failing in providing a database service after experiencing an anomaly of the second type, as shown in FIG. 2, a second database can be deployed in area 2 to store logs generated by performing database operations in the first database.

In response to the first database experiencing no anomaly, the data processing node and/or the data protection node asynchronously transmit/transmits logs to the second database, so as not to affect performance of the first database. The second database generally does not provide a database service, but updates data of the second database itself based on the logs, and the data of the second database is consistent with data of the first database before an asynchronous transmission delay time.

Although asynchronous transmission does not affect performance of the first database, data loss occurs in response to the first database experiencing an anomaly and failing to provide a database service. In some implementations, it is possible that a device such as a server/a disk/a communications device of each data processing node in the first database is damaged, and consequently each data processing node in the first database cannot perform a database operation. The anomaly of the first database can possibly be caused by a human factor or a force majeure factor such as a natural disaster.

In response to the first database experiencing an anomaly of the second type, the data protection node synchronizes, to the second database, the logs saved by the data protection node itself. The second database is configured to provide a database service after receiving the logs synchronized by the data protection node.

In response to the first database experiencing an anomaly of the second type, the master node performs a database operation and generates a latest log within the asynchronous transmission delay time. The latest log has not yet been transmitted to the second database, but must have been stored in at least one data protection node. The data protection node has black box characteristics, including an independent power supply and special protection capabilities such as resistance to strong impact, penetration, high temperatures and fire, pressure, seawater immersion, and corrosive liquid immersion. With these characteristics, the data protection node can preserve information stored inside the data protection node in various accidents. In addition, the data protection node is equipped with an independent communications apparatus, and can still maintain a communications capability after various accidents. Therefore, data or logs stored inside the data protection node will not be lost, and the data or logs stored inside the data protection node can be synchronized to the second database by using the independent communications apparatus. After the second database receives the latest log synchronized by the data protection node, updated data of the second database is the same as data of the first database before the anomaly. Then, the second database takes over to provide a database service.

It should be noted that the technical solutions discussed in the present application do not limit an architecture of the second database. The architecture of the second database can be the same as or different from that of the first database.

system in some implementations, the first database and the second database can be separately deployed in two different areas, which may increase the disaster recovery capabilities of the system. The data processing node and the data protection node in the first database can be deployed in different independent disaster recovery domains in the same area. The disaster recovery domains are independent of each other. Each independent disaster recovery domain includes at least one data processing node and at least one data protection node. Every two of the independent disaster recovery domains have a communication connection. In some implementations, as shown in FIG. 3, the first database is located in area 1, and the second database is located in area 2. Area 1 in which the first database is located includes three independent disaster recovery domains. One independent equipment room in area 1 can serve as one independent disaster recovery domain. Or a part of one independent equipment room in area 1 can serve as one independent disaster recovery domain. That is, in area 1, different independent equipment rooms are different independent disaster recovery domains, or different parts in the same independent equipment room are different independent disaster recovery domains.

The present application further provides a database disaster recovery method shown in FIG. 4, and the method is implemented by a data processing node in a first database. The first database can be a distributed database or a common database. The first database includes at least one data processing node and at least one data protection node. The data protection node and the data processing node are independent of each other. The method includes: S400: generating, in response to a received database operation, a log corresponding to the database operation; S402: synchronizing the log to all other data processing nodes and all data protection nodes in the first database, so that each of the data processing nodes and the data protection nodes synchronizes the log to at least one data protection node for storage under the condition of meeting distributed consistency; and S404: in response to the first database experiencing an anomaly of a first type and the data processing node itself experiencing no anomaly, providing a database service based on logs stored in the data protection node.

In some implementations, the first database is a distributed database, and the data processing node performs the method described in S400 to S404 after determining that the data processing node itself is a master node. All nodes in the first database meet a distributed consistency protocol during execution of a database operation. In addition, the master node synchronizes a log generated by performing the database operation to at least one data protection node.

As described above, a method for determining whether the log has been synchronized to at least one data protection node under the condition of meeting distributed consistency is in some implementations as follows: The data protection node determines, based on the number of all the data processing nodes, a weight of a log saving success message returned by the data protection node, and determines the sum of the weights of the log saving success messages returned by all the data protection nodes as a first weight; and determines, based on the number of all the data protection nodes, a weight of a log saving success message returned by the data processing node, and determines the sum of the weights of the log saving success messages returned by all the data processing nodes as a second weight; determines whether the sum of the first weight and the second weight is greater than a predetermined threshold; and in response to the sum of the first weight and the second weight being greater than the predetermined threshold, determines that the log has been synchronized to at least one data protection node under the condition of meeting distributed consistency; or in response to the sum of the first weight and the second weight being not greater than the predetermined threshold, determines that the log has not been synchronized to at least one data protection node under the condition of meeting distributed consistency. For example, in response to m data processing nodes and n data protection nodes being present, the weight of the log saving success message returned by the data processing node can be n or a multiple of n, and the weight of the log saving success message returned by the data protection node can be m or a multiple of m. m and n are natural numbers not less than 1.

An upper limit of the predetermined threshold is the total weight of log saving success messages in a case that all nodes return their respective log saving success messages. In response to m data processing nodes and n data protection nodes being present, assuming that the weight of the log saving success message returned by the data processing node is n and the weight of the log saving success message returned by the data protection node is m, the upper limit of the predetermined threshold is 2 mn, and the predetermined threshold can be mn or 1.5 mn. The predetermined threshold is not less than half of the upper limit, and is less than a natural number of the upper limit.

Continuing with the previous example, the weight of the log saving success message returned by the data processing node is n, the weight of the log saving success message returned by the data protection node is m, the predetermined threshold is mn, the number of the log saving success messages returned by all the data protection nodes is x, and the number of the log saving success messages returned by all the data processing nodes is y. In this case, the first weight is xn, the second weight is ym, and the sum of the first weight and the second weight is xn+ym. In response to xn+ym>mn, it is determined that the log has been synchronized to at least one data protection node under the condition of meeting distributed consistency.

Both x and y are natural numbers not less than 1, and x is not greater than the total number of the data protection nodes in the first database, and y is not greater than the total number of the data processing nodes in the first database.

In response to the first database experiencing an anomaly of the first type and the data processing node (master node) itself experiencing no anomaly, a database service is provided based on logs stored in the data protection node.

Further, in response to the first database experiencing an anomaly of the first type or a network between the data processing nodes encountering a problem, and an abnormal data processing node including the master node, the other data processing nodes without an anomaly need to determine a new master node, so that the newly determined master node performs a database operation and synchronizes a log as described above. However, it is possible that the other data processing nodes cannot determine the master node, and consequently, multiple nodes consider themselves as the master node.

Therefore, in response to the data processing node being incapable of determining the master node, a new master node needs to be determined in a vote-for-election manner. In some implementations, the first database further includes at least one election node. The election node is a special node in the first database for voting and electing a master node, which neither provides a database service nor needs to store data or logs. The election node is only configured to vote and elect the master node. It should be noted that an area in which the election node is located can be shown in FIG. 1. This area can be the same as or different from area 1 in which the data processing node and the data protection node are located.

For each of the data processing nodes, in response to determining that the data processing node itself is a master-eligible node, the data processing node sends a master node election request to the other data processing nodes and all the data protection nodes, and receives master node election messages returned by the other data processing nodes and all the data protection nodes; and in response to determining, based on the master node election messages, that the data processing node itself is the master node, the data processing node generates, in response to the received database operation, the log corresponding to the database operation, and synchronizes the log to all the other data processing nodes and all the data protection nodes in the first database.

In response to being incapable of determining the master node based on the master node election messages, the data processing node sends a master node election request to the other data processing nodes, all the data protection nodes, and the election node, receives master node election messages returned by the other data processing nodes, all the data protection nodes, and the election node, and determines the master node based on the master node election messages returned by the other data processing nodes, all the data protection nodes, and the election node.

In some implementations, the present application sets no limitation on a method for determining the master node. Alternatively, the master node can be determined by using predetermined priorities. To be specific, a priority can be predetermined for one master node and broadcast to all data processing nodes. Only when a data processing node with a higher priority is damaged or disconnected, a data processing node with a lower priority can serve as a master node to perform a database operation.

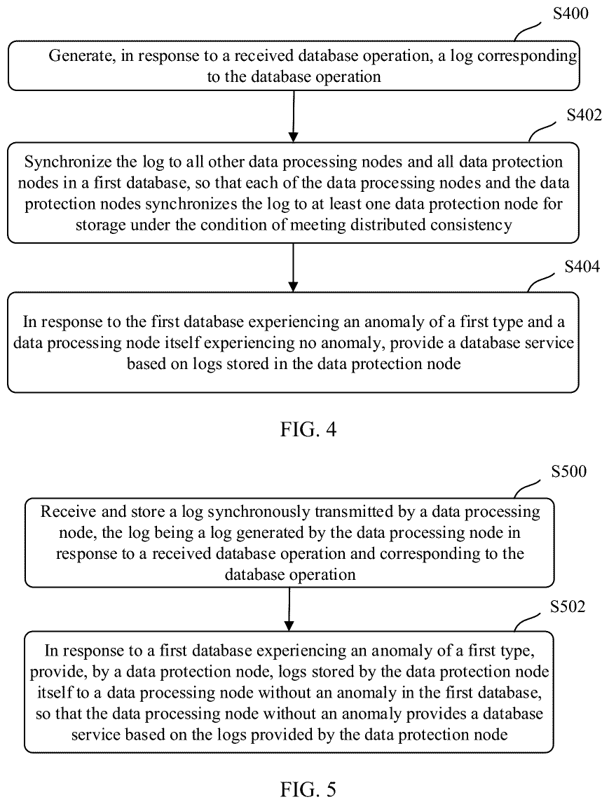

The present application provides a database disaster recovery method. As shown in FIG. 5, the method is applied to a data protection node in a first database, and the first database can be a distributed database or a common database. The first database includes at least one data processing node and at least one data protection node. The data protection node and the data processing node are independent of each other. The method includes: S500: receiving and store a log synchronously transmitted by the data processing node, the log being a log generated by the data processing node in response to a received database operation and corresponding to the database operation; and S502: in response to the first database experiencing an anomaly of a first type, providing, by the data protection node, logs stored by the data protection node itself to a data processing node without an anomaly in the first database, so that the data processing node without an anomaly provides a database service based on the logs provided by the data protection node.

The above step S500 and S502 are performed by the data protection node.

In response to the first database experiencing an anomaly of a second type, the logs saved by the data protection node are synchronized to a second database. The second database is configured to provide a database service after receiving the logs synchronized by the data protection node.

In some implementations, the data protection node can directly synchronize, to the second database, all the logs saved by the data protection node. In some implementations, to save resources, the data protection node can first check for a log in the data protection node that has not been saved to the second database, and synchronize the unsaved log to the second database. In response to multiple data protection nodes being present in the first database, each data protection node first checks for a log in the data protection node that has not been saved to the second database, and then synchronizes the unsaved log to the second database. In addition, it is expected that the log is synchronized as fast as possible, so that the second database can provide the database service as soon as possible after receiving the log synchronized by the data protection node.

In response to the first database experiencing no anomaly, the data protection node asynchronously transmits, to the second database, the logs saved by the data protection node itself, so as not to affect performance of the first database.

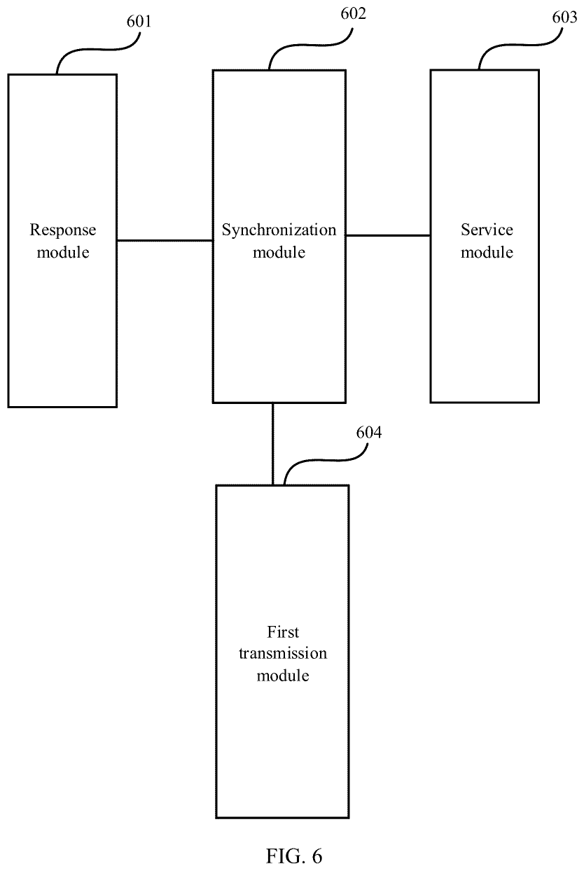

The above description is the database disaster recovery method provided in one or more implementations of the present specification. Based on the same idea, the present specification further provides a corresponding database disaster recovery apparatus, as shown in FIG. 5 or FIG. 6.

FIG. 6 is a schematic diagram of a database disaster recovery apparatus according to the present specification. The apparatus is applied to a data processing node in a first database. The first database includes at least one data processing node and at least one data protection node. The data protection node and the data processing node are independent of each other. The apparatus includes: a response module 601, configured to generate, in response to a received database operation, a log corresponding to the database operation; a synchronization module 602, configured to synchronize the log to all other data processing nodes and all data protection nodes in the first database, so that each of the data processing nodes and the data protection nodes synchronizes the log to at least one data protection node for storage under the condition of meeting distributed consistency; and a service module 603, configured to: in response to the first database experiencing an anomaly of a first type and the apparatus itself experiencing no anomaly, provide a database service based on logs stored in the data protection node.

In some implementations, the data protection node has an independent power supply and an independent communications apparatus.

In some implementations, the synchronization module 602 is in some implementations configured to: synchronize the log to all the other data processing nodes and all the data protection nodes in the first database for storage; receive log saving success messages returned by the other data processing nodes and the data protection nodes; and determine, based on the log saving success messages, whether the log has been synchronized to at least one data protection node under the condition of meeting distributed consistency.

In some implementations, the synchronization module 602 is, in some implementations, configured to: determine, based on the number of all the data processing nodes, a weight of the log saving success message returned by the data protection node, and determine the sum of the weights of the log saving success messages returned by all the data protection nodes as a first weight; and determine, based on the number of all the data protection nodes, a weight of the log saving success message returned by the data processing node, and determine the sum of the weights of the log saving success messages returned by all the data processing nodes as a second weight; determine whether the sum of the first weight and the second weight is greater than a predetermined threshold; and in response to the sum of the first weight and the second weight being greater than the predetermined threshold, determine that the log has been synchronized to at least one data protection node under the condition of meeting distributed consistency; or in response to the sum of the first weight and the second weight being not greater than the predetermined threshold, determine that the log has not been synchronized to at least one data protection node under the condition of meeting distributed consistency.

In some implementations, the apparatus further includes a first transmission module 604, configured to: in response to the first database experiencing no anomaly, asynchronously transmit, to the second database, the logs saved by the apparatus itself.

In some implementations, the first database further includes at least one election node. The response module 601 is, in some implementations, configured to: in response to determining that the apparatus itself is a master-eligible node, send a master node election request to the other data processing nodes and all the data protection nodes; receive master node election messages returned by the other data processing nodes and all the data protection nodes; and in response to determining, based on the master node election messages, that the apparatus itself is a master node, generate, in response to the received database operation, the log corresponding to the database operation; and the synchronization module 602 is further configured to: in response to being incapable of determining the master node based on the master node election messages, send a master node election request to the other data processing nodes, all the data protection nodes, and the election node; receive master node election messages returned by the other data processing nodes, all the data protection nodes, and the election node; and determine the master node based on the master node election messages returned by the other data processing nodes, all the data protection nodes, and the election node.

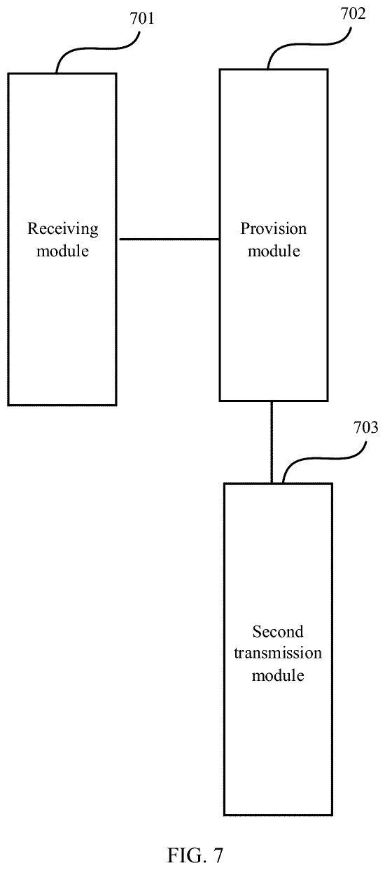

FIG. 7 is a schematic diagram of another database disaster recovery apparatus according to the present specification. The apparatus is applied to a data protection node in a first database. The first database includes at least one data processing node and at least one data protection node. The data protection node and the data processing node are independent of each other. The apparatus includes: a receiving module 701, configured to receive and store a log synchronously transmitted by the data processing node to the data protection node, the log being a log generated by the data processing node in response to a received database operation and corresponding to the database operation; and a provision module 702, configured to: in response to the first database experiencing an anomaly of a first type, provide logs stored by the apparatus itself to a data processing node without an anomaly in the first database, so that the data processing node without an anomaly provides a database service based on the logs provided by the apparatus.

In some implementations, the apparatus has an independent power supply and an independent communications apparatus.

In some implementations, the apparatus further includes a second transmission module 703, configured to: in response to the first database experiencing an anomaly of a second type, synchronize, to the second database, the logs saved by the apparatus itself, the second database being configured to provide a database service after receiving the logs synchronized by the apparatus.

In some implementations, the second transmission module 703 is in some implementations configured to: in response to the first database experiencing no anomaly, asynchronously transmit, to the second database, the logs saved by the apparatus itself.

The present specification further provides a computer-readable storage medium. The storage medium stores a computer program, and the computer program can be used to perform the database disaster recovery method provided in FIG. 4 or FIG. 5.

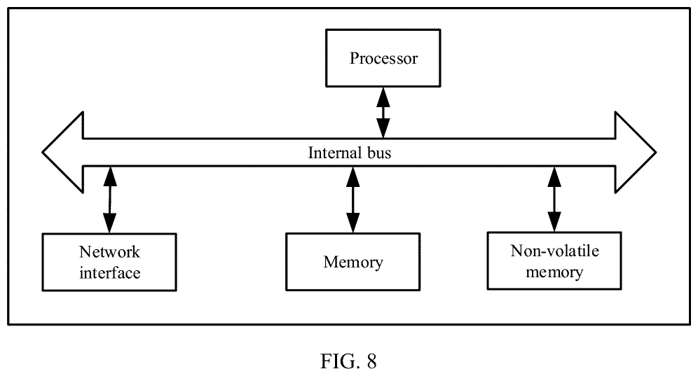

The present specification further provides a schematic structural diagram of an electronic device shown in FIG. 8. As shown in FIG. 8, at a hardware level, the electronic device includes a processor, an internal bus, a network interface, a memory, and a non-volatile memory, and can certainly include hardware required by other services. The processor reads a corresponding computer program from the non-volatile memory to the memory and then runs the computer program, to implement the database disaster recovery method provided in FIG. 4 or FIG. 5. Certainly, in addition to a software implementation, the present specification does not exclude other implementations, such as a logic device or a combination of software and hardware. In other words, an execution entity of the following processing flow is not limited to each logic unit, but can also be hardware or logic devices.

In the 1990s, whether a technical improvement is a hardware improvement (for example, an improvement to a circuit structure, such as a diode, a transistor, or a switch) or a software improvement (an improvement to a method procedure) can be clearly distinguished. However, as technologies develop, current improvements to many method procedures can be considered as direct improvements to hardware circuit structures. A designer usually programs an improved method procedure into a hardware circuit, to obtain a corresponding hardware circuit structure. Therefore, a method procedure can be improved by using a hardware entity module. For example, a programmable logic device (PLD) (for example, a field programmable gate array (FPGA)) is such an integrated circuit, and a logical function of the PLD is determined by a user through device programming. The designer performs programming to “integrate” a digital system to a PLD without requesting a chip manufacturer to design and produce an application-specific integrated circuit chip. In addition, at present, instead of manually manufacturing an integrated circuit chip, such programming is mostly implemented by using “logic compiler” software. The logic compiler software is similar to a software compiler used to develop and write a program. Original code needs to be written in a particular programming language for compilation. The language is referred to as a hardware description language (HDL). There are many HDLs, such as the Advanced Boolean Expression Language (ABEL), the Altera Hardware Description Language (AHDL), Confluence, the Cornell University Programming Language (CUPL), HDCal, the Java Hardware Description Language (JHDL), Lava, Lola, MyHDL, PALASM, and the Ruby Hardware Description Language (RHDL). The very-high-speed integrated circuit hardware description language (VHDL) and Verilog are most commonly used. A person skilled in the art should also understand that a hardware circuit that implements a logical method procedure can be readily obtained once the method procedure is logically programmed by using the several described hardware description languages and is programmed into an integrated circuit.

A controller can be implemented by using any appropriate method. For example, the controller can be a microprocessor or a processor, or a computer-readable medium that stores computer readable program code (such as software or firmware) that can be executed by the microprocessor or the processor, a logic gate, a switch, an application-specific integrated circuit (ASIC), a programmable logic controller, or a built-in microprocessor. Examples of the controller include but are not limited to the following microprocessors: ARC 625D, Atmel AT91SAM, Microchip PIC18F26K20, and Silicone Labs C8051F320. The memory controller can also be implemented as a part of the control logic of the memory. A person skilled in the art also knows that, in addition to implementing the controller by using the computer readable program code, logic programming can be performed on method steps to allow the controller to implement the same function in forms of the logic gate, the switch, the application-specific integrated circuit, the programmable logic controller, and the built-in microcontroller. Therefore, the controller can be considered as a hardware component, and an apparatus configured to implement various functions in the controller can also be considered as a structure in the hardware component. Or the apparatus configured to implement various functions can even be considered as both a software module implementing the method and a structure in the hardware component.

The systems, apparatuses, modules, or units illustrated in the above-mentioned implementations can be implemented by using a computer chip or an entity, or can be implemented by using a product having a certain function. A typical implementation device is a computer. In some implementations, the computer can be, for example, a personal computer, a laptop computer, a cellular phone, a camera phone, a smartphone, a personal digital assistant, a media player, a navigation device, an email device, a game console, a tablet computer, or a wearable device, or a combination of any of these devices.

For ease of description, the apparatus above is described by dividing functions into various units. Certainly, when the present specification is implemented, a function of each unit can be implemented in one or more pieces of software and/or hardware.

A person skilled in the art should understand that the implementations of the present application can be provided as a method, system, or computer program product. Therefore, the present application can use a form of hardware only implementations, software only implementations, or implementations with a combination of software and hardware. In addition, the present application can use a form of a computer program product that is implemented on one or more computer-usable storage media (including but not limited to a disk storage, a CD-ROM, an optical storage, or the like) that include computer-usable program code.

The present application is described with reference to the flowcharts and/or block diagrams of the method, the device (system), and the computer program product according to the implementations of the present application. It should be noted that computer program instructions can be used to implement each process and/or each block in the flowcharts and/or the block diagrams and a combination of a process and/or a block in the flowcharts and/or the block diagrams. These computer program instructions can be provided for a general-purpose computer, a dedicated computer, an embedded processor, or a processor of another programmable data processing device to generate a machine, so the instructions executed by the computer or the processor of the another programmable data processing device generate an apparatus for implementing a specific function in one or more processes in the flowcharts and/or in one or more blocks in the block diagrams.

These computer program instructions can be stored in a computer readable memory that can instruct the computer or the another programmable data processing device to work in a specific way, so the instructions stored in the computer readable memory generate an artifact that includes an instruction apparatus. The instruction apparatus implements a specific function in one or more processes in the flowcharts and/or in one or more blocks in the block diagrams.

These computer program instructions can be loaded to the computer or the another programmable data processing device, so that a series of operations and steps are performed on the computer or the another programmable device, thereby generating computer-implemented processing. Therefore, the instructions executed on the computer or the another programmable device provide steps for implementing a specific function in one or more processes in the flowcharts and/or in one or more blocks in the block diagrams.

In a typical configuration, a computing device includes one or more central processing units (CPUs), input/output interfaces, network interfaces, and memories.

The memory can include a non-persistent memory, a random access memory (RAM), and/or a non-volatile memory in a computer-readable medium, for example, a read-only memory (ROM) or a flash read-only memory (flash RAM). The memory is an example of the computer-readable medium.

The computer-readable medium includes persistent, non-persistent, removable, and non-removable media that can store information by using any method or technology. The information can be computer-readable instructions, a data structure, a program module, or other data. Examples of a computer storage medium include but are not limited to a phase change random access memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a cassette magnetic tape, a tape and disk storage or another magnetic storage device or any other non-transmission media that can be configured to store information that a computing device can access. As described in the present specification, the computer-readable medium does not include transitory computer-readable media (transitory media) such as a modulated data signal and a carrier.

It should also be noted that the terms “include”, “comprise”, or any other variants thereof are intended to cover a non-exclusive inclusion, so that a process, a method, a product, or a device that includes a list of elements not only includes those elements but also includes other elements that are not expressly listed, or further includes elements inherent to such a process, method, product, or device. Without more constraints, an element preceded by “includes a . . . ” does not preclude the existence of additional identical elements in the process, method, product, or device that includes the element.

A person skilled in the art should understand that the implementations of the present specification can be provided as a method, a system, or a computer program product. Therefore, the present specification can use a form of hardware only implementations, software only implementations, or implementations with a combination of software and hardware. Moreover, the present specification can use a form of a computer program product that is implemented on one or more computer-usable storage media (including but not limited to a disk memory, a CD-ROM, an optical memory, etc.) that include computer-usable program code.

The present specification can be described in the general context of computer-executable instructions executed by a computer, for example, a program module. Generally, the program module includes a routine, a program, an object, a component, a data structure, etc. executing a specific task or implementing a specific abstract data type. The present specification can alternatively be practiced in distributed computing environments in which tasks are performed by remote processing devices that are connected through a communication network. In a distributed computing environment, the program module can be located in both local and remote computer storage media including storage devices.

The implementations of the present specification are described in a progressive manner. For same or similar parts of the implementations, mutual references can be made to the implementations. Each implementation focuses on a difference from the other implementations. Particularly, the system implementations are basically similar to the method implementations, and therefore are described briefly. For related parts, references can be made to some descriptions of the method implementations.

The above-mentioned descriptions are merely some implementations of the present specification, and are not intended to limit the present specification. A person skilled in the art can make various variations and changes to the present specification. Any modification, equivalent replacement, and improvement made in the spirit and principle of the present specification shall fall within the scope of the claims in the present application.

What is claimed is:

1. A database disaster recovery system, comprising at least a first database, the first database including at least one data processing node and at least one data protection node, a data protection node of the at least one data protection node and a data processing node of the at least one data processing node being separate from each other,
wherein:
a data processing node of the at least one data processing node is operable to generate, in response to a database operation, a log corresponding to the database operation, and send the log to all other data processing node and the at least one data protection node of the first database for at least one data protection node of the first database to synchronize the log, with each of the at least one data processing node and the at least one data protection node meeting distributed consistency;
the data protection node of the first database is operable to receive and store the log sent by the data processing node; and
in response to the first database experiencing an anomaly of a first type, a data processing node of the first database having no anomaly is operable to provide a database service based on a log stored in the data protection node.

2. The system according to claim 1, wherein the data protection node has a separate power supply and a separate communications apparatus from the at least one data processing node.

3. The system according to claim 1, wherein the data processing node is operable to receive a log saving success message returned by the other data processing node or the data protection node, and determine, based on the log saving success message, whether the log has been synchronized on at least one data protection node with distributed consistency being met.

4. The system according to claim 3, wherein the data processing node is operable to
determine, based on a number of all data processing node, a weight of the log saving success message returned by a data protection node, and determine as a first weight a sum of weight of all log saving success message each returned by a data protection node;
determine, based on a number of all the data protection node, a weight of the log saving success message returned by a data processing node, and determine as a second weight a sum of weight of all log saving success message each returned by a data processing node; and
in response to a sum of the first weight and the second weight being greater than a threshold, determine that the log has been synchronized on at least one data protection node with distributed consistency being met.

5. The system according to claim 1, further comprising a second database, wherein:
in response to the first database experiencing an anomaly of a second type, the data protection node is configured to send, to the second database, a log saved by the data protection node; and
the second database is configured to provide a database service after receiving the log sent by the data protection node.

6. The system according to claim 5, wherein in response to the first database experiencing no anomaly, one or more of the data processing node or the data protection node are configured to asynchronously transmit, to the second database, a log saved by the one or more of the data processing node or the data protection node.

7. The system according to claim 1, wherein for each of the at least one data processing node:
in response to determining that the data processing node is a candidate to be elected as a master node, the data processing node is configured to send a first master node election request to other data processing node and the at least one data protection node, and to receive a first master node election message returned by one or more of the other data processing node or the at least one data protection node; and
in response to determining, based on the first master node election message, that the data processing node is a master node, the data processing node is configured to generate, in response to the received database operation, the log corresponding to the database operation, and send the log to all the other data processing node and all data protection node of the first database.

8. The system according to claim 7, wherein the first database further includes at least one election node, and
in response to being incapable of determining a master node based on the first master node election message, the data processing node is configured to send a second master node election request to the other data processing node, the at least one data protection node, and the at least one election node, to receive a second master node election message returned by one or more of the other data processing node, the at least one data protection node, or the at least one election node, and to determine the master node based on the second master node election message.

9. A database disaster recovery method, applied to a data processing node in a first database, the first database including at least one data processing node and at least one data protection node, a data protection node of the at least one data protection node and a data processing node of the at least one data processing node being separate from each other, and the method comprising:
generating, in response to a database operation, a log corresponding to the database operation;
sending the log to other data processing node of the at least one data processing node and the at least one data protection node of the first database for at least one data protection node of the first database to synchronize the log, with each of the at least one data processing node and the at least one data protection node meeting distributed consistency for storage; and
in response to the first database experiencing an anomaly of a first type and the data processing node itself experiencing no anomaly, providing a database service based on a log stored in the data protection node.

10. The method according to claim 9, wherein the data protection node has a separate power supply and a separate communications apparatus from the at least one data processing node.

11. The method according to claim 9, wherein the sending the log for the data protection node of the first database to synchronize the log includes:
sending the log to the other data processing node and the at least one data protection node of the first database for storage;
receiving a log saving success message returned by one or more of the other data processing node or the at least one data protection node; and
determining, based on the log saving success message, whether the log has been synchronized on the data protection node with distributed consistency being met.

12. The method according to claim 11, wherein the determining whether the log has been synchronized to at least one data protection node with distributed consistency being met includes:
determining, based on a number of all the data processing node, a weight of the log saving success message returned by a data protection node, and determining as a first weight a sum of weight of all log saving success message returned by a data protection node;
determining, based on a number of all the data protection node, a weight of the log saving success message returned by a data processing node, and determining as a second weight a sum of weight of all log saving success message returned by a data processing node;
determining whether a sum of the first weight and the second weight is greater than a threshold; and
in response to a sum of the first weight and the second weight being greater than the threshold, determining that the log has been synchronized on at least one data protection node with distributed consistency being met; or
in response to a sum of the first weight and the second weight being not greater than the predetermined threshold, determining that the log has not been synchronized on at least one data protection node with distributed consistency being met.

13. The method according to claim 9, further comprising:
in response to the first database experiencing no anomaly, asynchronously transmitting, to a second database, a log saved by the data processing node.

14. The method according to claim 9, wherein
the generating, in response to the database operation, the log corresponding to the database operation includes:
in response to determining that the data processing node is a candidate to be elected as a master node, sending a first master node election request to the other data processing node and the at least one data protection node;
receiving a first master node election message returned by one or more of the other data processing node or the at least one data protection node; and
in response to determining, based on the master node election message, that the data processing node is a master node, generating, in response to the database operation, the log corresponding to the database operation; and

15. The method according to claim 14, wherein the first database further includes at least one election node, and the method further comprises:
in response to being incapable of determining a master node based on the first master node election message, sending a second master node election request to the other data processing node, the at least one data protection node, and the at least one election node;
receiving a second master node election message returned by one or more of the other data processing node, the at least one data protection node, or the at least one election node; and
determining the master node based on the second master node election message.

16. A database disaster recovery method, applied to a data protection node in a first database, the first database including at least one data processing node and at least one data protection node, a data protection node of the at least one data protection node and a data processing node of the at least one data processing node being separate from each other, and the method comprising:
receiving and storing a log transmitted by the data processing node, the log being a log generated by the data processing node in response to a database operation and corresponding to the database operation; and
in response to the first database experiencing an anomaly of a first type, providing, by the data protection node, a log stored by the data protection node to a first data processing node not having the anomaly of the first database for the first data processing node to provide a database service based on the log provided by the data protection node.

17. The method according to claim 16, wherein the data protection node has s separate power supply and a separate communications apparatus from the at least one data processing node.

18. The method according to claim 16, further comprising:
in response to the first database experiencing an anomaly of a second type, sending, to a second database, a log saved by the data protection node, the second database being configured to provide a database service after receiving the log sent by the data protection node.

19. The method according to claim 16, further comprising:
in response to the first database experiencing no anomaly, asynchronously transmitting, to a second database, a log saved by the data protection node.

20. The method of claim 16, further comprising:
sending a log saving success message to the data processing node, the log saving success message indicating the log has been synchronized on the data protection node with distributed consistency being met.
